(19) United States
(12) Patent Application Publication
(10) Pub. No.: US 2009/0197678 A1
(43) Pub. Date: Aug. 6, 2009

(54) Pretend play toy with reality and virtual interaction

(76) Inventor: Chung-Jen Huang, Hong Kong (HK)

Correspondence Address: ROSENBERG, KLEIN & LEE, 3458 ELLICOTT CENTER DRIVE-SUITE 101, ELLICOTT CITY, MD, 21043, US

(21) Appl. No.: 12/068,131

(22) Filed: Feb. 4, 2008

(51) Int. Cl. A63F 13/06

(52) U.S. Cl. 463/32

(57) ABSTRACT

A pretend play toy with virtual reality interaction is disclosed. Children play toys on a platform in pretend play, and a circuit board underneath unseen by the children can sensor toys' characters and positions for playing virtual scene on the display where the children have interaction with the virtual playground. The present invention combines the physical toys and children's imagination on the display like TV, and let the children unconsciously learn and enhance their creativity and imagination.

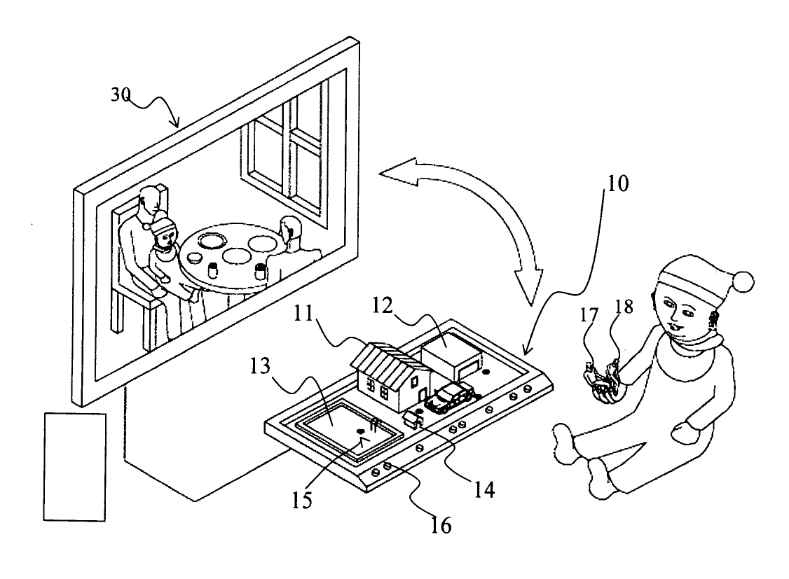

### BACKGROUND OF THE INVENTION

1. Field of the Invention

The present invention generally relates to a pretend play toy, and more particularly relates to a pretend play toy with virtual reality interaction.

2. Description of the Prior Art

The pretend play is Children begin to engage in pretend play, develop receptive and expressive language, and use mental representation at approximately the same time in their development. Pretend play requires the ability to transform objects and actions symbolically; it is carried out through interactive social dialogue and negotiation; and it involves role taking, script knowledge, and improvisation. Lillard (1998) has pointed out that pretend play involves negotiation between players with differing views, simultaneous representation of objects in two ways (real and pretend), role play requiring acting out others' thoughts and actions, and portrayal of emotions appropriate to varied situations and actors-all actions that suggest that the pretenders have mental representation abilities.

Although pretend play has long been part of the early childhood curriculum, recent emphasis on accountability in education seems to have led to a decline in the general understanding of the contribution that high-quality play can make to children's cognitive development in the early years.

However, since the toys are fixed and lack of response, the interaction has been limited to only one-way interaction—from children to toys. If this interaction could be bi-directional and supported by rich multimedia contents, it could stimulate children's creativity and imagination even more.

### SUMMARY OF THE INVENTION

In order to solve the aforementioned problems, one object of the present invention is to provide a pretend play toy, which utilizes a game platform connected to a display. Therefore, the present invention can connect the physical environment and imagination, and provide an education and entertainment experiences for children from the pretend play.

The present invention thus provides an entertainment toy and combines the real objects in the pretend play, and the virtual playground or story in the screen to stimulate children's creativity and imagination.

Accordingly, one embodiment of the present invention provides a pretend play toy with reality and virtual interaction, which includes: a first game platform having a plurality of sensing spots, and a plurality of control units for a user to control the game platform as the user plays pretend play, and a processor resided in a circuit board receiving control-signal from the sensing spots and the control units, then outputting an audio/video (AV) signals; at least a game object having an ID unit representative of a virtual character.

Other advantages of the present invention will become apparent from the following description taken in conjunction with the accompanying drawings wherein are set forth, by way of illustration and example, certain embodiments of the present invention.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

The FIGURE is the embodiment of pretend play toy with virtual reality interaction according to the present invention.

### DESCRIPTION OF THE PREFERRED EMBODIMENT

The present invention includes a game platform and several game objects; the game platform has several sensing spots and control units for a user to control the game platform while the user playing pretend play, has an area supporting several game objects, such as house model or toy figure, and has a processor resided in a circuit board receiving control-signal from the sensing spots and the control units; then it outputs an audio/video (AV) signals to a display; the processor transmits the relative screen to the display via wire or wireless transmission. Also, the game object has an ID unit representative of a virtual character, is placed on the game platform, sensed through the sensing spots and identified the position and virtual character of the game object. The processor outputs the first playing scene of the game platform and the position and the virtual character of the game object to a display, and produces a relative screen and leads the user enter a virtual play ground or next virtual play ground.

The scenes in the pretend play have any possibilities for children to imagine broadly, and the present invention combines the reality in the play and virtual pretend play in the mind, and extends the traditional pretend play to virtual reality characters in the display like TV. By playing this way, the present invention can connect the physical environment and imagination and provide an education and entertainment experiences for children from the pretend play. In addition, the game platform connects to another game platform with a different playing scene, when the game object is changed its position to another game platform and the playing scene also changed to different playing scene in the display.

Referring the FIGURE is the embodiment of pretend play toy with virtual reality interaction according to the present invention. In the embodiment, a pretend play's scene has two toy figure or human figurines, Frank 17 and Susan 18, and two virtual characters, father and mother, in playing scene. A game platform 10 supports several construction toys, such as a house model 11, a garage 12, a swimming pool 13, a doghouse 14 and so on. When the story of pretend play goes on, from the morning till night at one day the children moves the human figurines, Frank 17 and Susan 18, around the game platform 10 upon the display 30. Example, when the virtual characters, father and mother, calls Frank 17 and Susan 18 for launch, the children put Frank 17 and Susan 18 into the house model 11, and the circuit board underneath will sense and identify both game objects via sensing spots 15. After the game objects put in front of the house model 11 Frank 17 and Susan 18 are shown in launch eating scene and a detailed and elaborate kitchen background is shown in the display 30 with food information for children knowing. If the human figurines are not sensed, father and mother will keep calling children for launch.

Accordingly, if the game objects, Frank and Susan, are put in front of doghouse 14, the scene of children playing with dog is displayed on the screen of the display 30. In another virtual playground, Frank 17 and Susan 18 are put in the swimming pool 13, the scene of children playing water or swimming race is displayed on the screen of the display 30.

The digital content of virtual playground or scene is stored in a memory, which is controlled as the children move one or more game objects around the game platform and control units (or bottom 16). The virtual playground can be a zoo, park, garage, school, garden or fire brigade, etc.

If the Frank and Susan are placed in the room for studying, there are language and math questions or geographical information on the screen of display for children to push the bottom 16 of game platform to answer the questions. The toy figure at each position has several playground scenes shown randomly. In some scene the children can play parent characters, for instance the father drives car to travel, the screen will turn to father role, and the children will obey the traffic rules, thus let the children learn the signs and lights in the driving simulation.

Accordingly, the toy figure on the game platform is very simple and rough, and easy to make, but virtual construction the construction toys present can be sophisticated and delicate by way of software engineering works. The cost to produce the construction toy will not be expensive but the pretend play becomes more interesting. In some playground, the family go to travel to New York's to see the Metropolitan Museum of Art, the children put the toy figure in front of the building model of the Metropolitan Museum of Art on the game platform, the virtual graphic will display in the display and the children use the bottoms of the game platform to control the views of the Metropolitan Museum of Art from inside or outside, and by any angle. The children will learn more than from just playing the building model, and getting more fun from this invention.

Accordingly, the simple block of construction toy, like museum or art house, can present its art display in virtual playground when it is placed in the game platform, so the children may go to virtual museum in the pretend play. The pretend play is very intelligent game for children by virtual pretend travel; it can help some children without any chance to travel the world.

Game platform has many sensing spots and control units for children to control the game platform. In one embodiment, the game platform can connect to a second game platform with a second playing scene, when the game object changed to the second game platform and the first playing scene changed to second playing scene in the display. In consequence of connecting several game platforms together, the pretend play will expand to many virtual playgrounds, and the person interaction in various game platforms makes the present invention more interesting. Each game platform with a specified story content precedes a sequence of scenes when the time goes by, for instance two virtual hosts lead the children doing tasks from the morning to the night, the virtual host can be a parent at home, the captain in a fire brigade, or a tour guide in a playground.

The game object can present any possible people in real life, including: human figurine or an animal figurine, construction toy, a building model or a vehicle model, furniture model or facility. Those game objects all with ID unit for their virtual characters are identified by the circuit board. For instance, in a home scenario Frank and Susan are two figurines, the parent are virtual roles in the screen, or reversely. Moreover, though the game object may be simple and roughly constructed of a variety of materials, such as plastic, steel, or various combinations of such materials, the virtual scenes shown on the display are colorful and vivid, thereof detailed and splendid background, interactive and emotional characters with elegant dressing, all shown on the display have wonderful look than the game object's. So the present invention brings the children with low cost but most interesting pretend play than traditional pretend play.

Accordingly, the present invention combines the real objects in the pretend play and the virtual playground with various stories in the screen to stimulate children's creativity and imagination even more.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A pretend play toy with virtual reality interaction comprising:
a first game platform having a plurality of sensing spots, and a plurality of control units for a user to control the game platform as the user plays pretend play, and a processor resided in a circuit board receiving control-signal from the sensing spots and the control units, then outputting an audio/video (AV) signals; and
at least a game object having an ID unit representative of a virtual character; wherein
the game object is placed on the game platform, sensed through the sensing spots, and identified the position and virtual character of the game object; and
the processor outputs the first playing scene of the game platform, the position and the virtual character of the game object to a display, produces a relative screen, and leads the user to enter a virtual playground or next virtual playground.

2. The pretend play toy with virtual reality interaction according to claim 1, wherein the display is a TV.

3. The pretend play toy with virtual reality interaction according to claim 1, wherein the game object is a toy figure.

4. The pretend play toy with virtual reality interaction according to claim 3, wherein the toy figure is a human figurine or an animal figurine.

5. The pretend play toy with virtual reality interaction according to claim 1, wherein the game object is a construction toy.

6. The pretend play toy with virtual reality interaction according to claim 5, wherein the construction toy is a building model or a vehicle model.

7. The pretend play toy with virtual reality interaction according to claim 1, wherein the game object is a furniture model or facility model.

8. The pretend play toy with virtual reality interaction according to claim 1, wherein the virtual playground is stored in a memory and controlled by the processor.

9. The pretend play toy with virtual reality interaction according to claim 1, wherein the virtual playground is a zoo, park, garage, school, garden or fire brigade.

10. The pretend play toy with virtual reality interaction according to claim 1, wherein the virtual play ground is a museum or an art house.

11. The pretend play toy with virtual reality interaction according to claim 1, wherein the game platform transmits the relative screen to the display via wire transmission or wireless transmission.

12. The pretend play toy with virtual reality interaction according to claim 1, wherein the first game platform connects to a second game platform with a second playing scene, when the game object is changed to the second game platform and the first playing scene changed to the second playing scene in the display.
